(19) United States
(12) Patent Application Publication
(10) Pub. No.: US 2026/0278566 A1
(43) Pub. Date: Sep. 17, 2026

(54) Systems and Methods For Authenticating Paper or Electronic Checks

(71) Applicant: ORSO LLC

(72) Inventor: Raymond Pianta

(73) Assignee: ORSO LLC, (US)

(21) Appl. No.: 19/080,398

(22) Filed: Mar. 14, 2025

(51) Int. Cl. G06Q 20/04; G06Q 20/40

(52) U.S. Cl. CPC G06Q 20/042; G06Q 20/4014

(57) ABSTRACT

Systems and methods for authentication of paper and electronic checks are disclosed which include a server configured to store a set of information in a database including a plurality of approved transactions. The server receives information about a first transaction and compares it to the approved transactions. If a match is found, the server automatically transmits an authorization code to approve the transaction. If no match is found, the server may transmit a decline code or request approval from the account holder.

### FIELD OF THE INVENTION

The field of the invention is financial transaction processing.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Paper checks remain a critical payment method for many individuals and organizations, including payroll disbursement and person transactions. Cashier’s checks are especially popular as they are guaranteed by the issuing bank. However, checks and cashier’s checks are nonetheless susceptible to fraud, including forgery, alteration, and theft. It is often not possible to verify a check’s validity without calling or visiting the bank that issued the check.

Traditional check processing systems generally relies on manual verification processes or basic automated matching of account numbers and signatures. These approaches can be time-consuming, error-prone, and may not adequately protect against sophisticated fraud attempts. Existing systems attempt to address these issues by implementing electronic check imaging and optical character recognition. However, such processes are often still vulnerable to counterfeiting of check stock or manipulation of printed information. Additionally, such processes generally do not provide real-time verification capabilities, potentially allowing fraudulent transactions to be processed before they can be detected.

Thus, there is still a need for systems and methods that allow for robust, real-time authentication of paper and electronic checks.

### SUMMARY OF THE INVENTION

The inventive subject matter is directed to apparatus, systems, and methods for authenticating paper or electronic checks.

For example, in a first embodiment, the inventors contemplate a system for authenticating paper or electronic checks that includes a server configured to store a set of information in a database, which may include, for example, a plurality of approved transactions. The server is configured to receive a first transaction and compare information about the first transaction with the information of the approved transactions in the database to determine whether the first transaction matches one of the plurality of approved transactions. If the first transaction matches one of the plurality of approved transactions, the server automatically transmits an authorization code to cause the first transaction to be approved.

In another aspect, if the first transaction does not match one of the plurality of approved transactions, the server may automatically transmit a decline code to decline or flag the first transaction. It is further contemplated in such circumstances that the server could send a request to the account holder via text message, push notification, or other communication protocol for approval of the transaction, such as by the account holder providing a unique code which may be automatically generated such as by using two-factor authentication or a software app that generated one-time passcodes, for example.

In another aspect, the inventors contemplate a method of authenticating paper or electronic checks, where the method comprises receiving information at a server about a plurality of approved transactions and storing that information in a database. The server may comprise a processor and a memory. The method may further involve receiving information about a first transaction at the server. The processor may compare the information about the first transaction with the information of the plurality of approved transactions to determine whether the first transaction matches one of the plurality of approved transactions. If the first transaction matches one of the plurality of approved transactions, the processor may automatically transmit an authorization code to approve the first transaction.

In still further embodiments, the first transaction does not match one of the plurality of approved transactions, the processor may automatically transmit a decline code to decline or flag the first transaction. It is also contemplated that the server could send a request for confirmation of the transaction to the account holder such as described above.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates one embodiment of a method of authenticating paper or electronic checks.

FIG. 2 illustrates a system for authenticating paper or electronic checks.

FIG. 3 illustrates a system for authenticating steps, corresponding to the components taught in the description below.

### DETAILED DESCRIPTION

Throughout the following discussion, numerous references will be made regarding servers, services, interfaces, portals, platforms, neural network models, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The terms, “component”, “module”, "system”, and the like used herein indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

Illustrative logical blocks, configurations, modules, circuits, means, logic, and algorithm operations described herein may be implemented by electronic hardware, computer software, or in a combination of electronic hardware and computer software. In order to clearly exemplify interchangeability of hardware and software, the algorithms, steps and/or operations have been generally described in the functional aspects thereof. Whether the functionality is implemented as hardware or software depends on the specific application or design restraints given to the system.

Embodiments of the inventions described herein may include or utilize a special purpose or general-purpose computer that includes one or more servers and/or other computer hardware. The one or more servers can each include, for example, one or more processors and system memory. The computer can also include physical and other computer-readable media for carrying or storing computer-executable instructions and/or data structures. Such instructions can facilitate the systems and methods described and may be stored in a non-transitory computer-readable medium and executable by the one or more servers or other computing devices. As an example, a processor may receive instructions from a non-transitory computer-readable medium and execute those instructions to perform one or more processes.

Computer-readable media can be any available media that can be accessed by a general purpose or special purpose computer system. Examples of computer-readable media include RAM, ROM, EEPROM, solid state drives, Flash memory, and other optical disk storage, magnetic disk storage or other magnetic storage devices, or any other medium which can be used to store desired application code in the form of computer-executable instructions or data structures, and which can be accessed by a general purpose or special purpose computer.

Computer-executable instructions include, for example, instructions and data which, when executed at a processor, cause a general-purpose computer, special purpose computer, or special purpose processing device to perform a certain function or group of functions. In some embodiments, computer-executable instructions are executed on a general-purpose computer to tum the general-purpose computer into a special purpose computer implementing elements of the disclosure. The computer executable instructions may be, for example, binaries, intermediate format instructions such as assembly language, or even source code.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

The systems and methods described herein may utilize various communication protocols including, for example, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

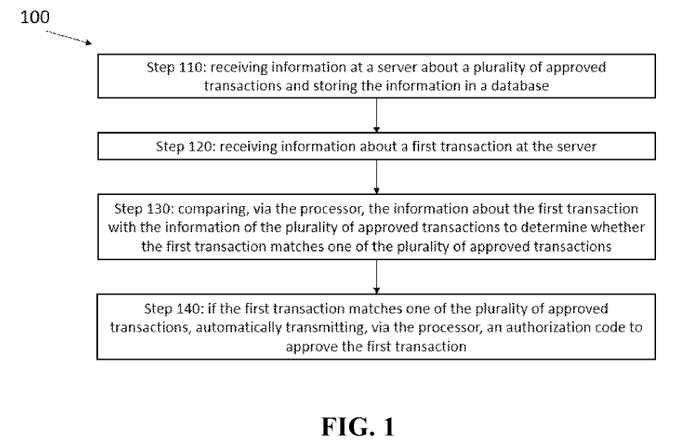

FIG. 1 illustrates one embodiment of a method 100 for authenticating paper or electronic checks. In step 110, information about a plurality of approved transactions is received at a server and stored in a database. Typically, the server comprises a processor and a memory. The server may be a database server (e.g., DBMS server) that may be used to store customer information, transaction records, and/or other financial data. However, the server may be a core banking server (CBS), an application server, a file server, or any other type of server.

In step 120, information about a first transaction is received at the server. The first transaction may be any attempt to deposit a check or process a transaction involving a paper or electronic check, for example. For a paper check, the transaction could include, for example, a paper check deposited at a bank or ATM, or a remote deposit capture of a paper check submitted through a mobile or desktop banking app. The first transaction may alternatively comprise a different aspect of how a check is processed, such as the process by which a check moves from a payee’s bank to a payer’s bank for approval, or by which a check is processed between two different banks, or any other processing of checks. Accordingly, a check may refer to a personal check, a cashier's check, a certified check, an electronic check including an ACH payment, a counter check, and other financial instruments and transactions.

The information received about the first transaction could include one or more of a check number, a payee, an amount, a date of the transaction or printed date on the check, a signature, an image of the check, a printed code, image or other indicia printed on the check, and so forth.

In step 130, the processor compares the received information about the first transaction with the information of the plurality of approved transactions in the database to determine whether the first transaction matches one of the plurality of approved transactions. It should be appreciated that the first transaction may be associated with a paper check, and the paper check may comprise a check number, a payee, an amount, a date, and a signature. Therefore, step 130 may involve, as an example, determining whether the check number and the amount matches a check number and amount of one of the plurality of approved transactions.. Of course, the comparison could involve additional or different information of the first transaction including, for example, comparing an indicia on the check with indicia in the database, comparing a payee on the check with payees in the database, and so forth. Preferably, two or more pieces of information are compared in the database to ensure only preauthorized transactions are approved.

In step 140, if the first transaction matches one of the plurality of approved transactions, the processor automatically transmits an authorization code to approve the first transaction. The inventors contemplate that the approved transactions may comprise many different data or a combination of data that must match the first transaction before an authentication code can be transmitted to approve the first transaction. Additionally, an account holder can independently control which data is included in the approved transaction, enabling individualized security. For example, the account holder can specify payee details, such as the payee name, account number, routing number, location, or other identifying information to the system, allowing the system to flag or decline checks that do not match the specified information.

Further, the account holder can specify the amount of the check, preventing a bad actor from increasing or decreasing the amount of the check with fraudulent intent. Still further, the account holder can set an activation duration (e.g., date and/or time range) wherein the first transaction will not be approved if the first transaction is processed outside of the activation duration. As an example, the account holder may specify a 24-hour period in which the first transaction may be approved, and the first transaction will be flagged and declined if the first transaction occurs outside of the set time period. It is contemplated that any such specifications may be optional, allowing an account holder to vary the activation restrictions of every individual check/transaction.

It is further contemplated that the account holder can deactivate or remove one or more of the approved transactions from the database to prevent authentication of those transactions. Information about the approved transactions can also be updated as needed, such as to change a payee or amount or change the activation duration associated with an approved transaction. In a further embodiment, it is contemplated that a full audit trail can be maintained for each transaction, including activation and transaction details. The audit trail may be accessed by the account holder.

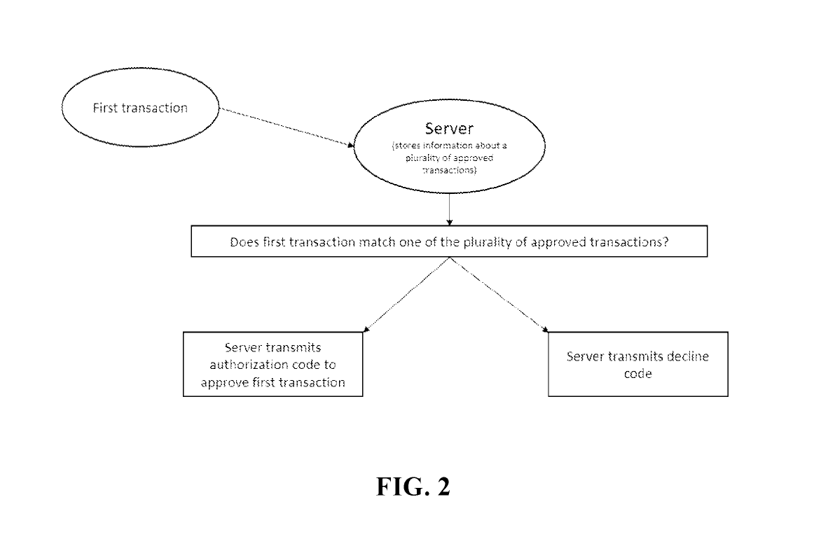

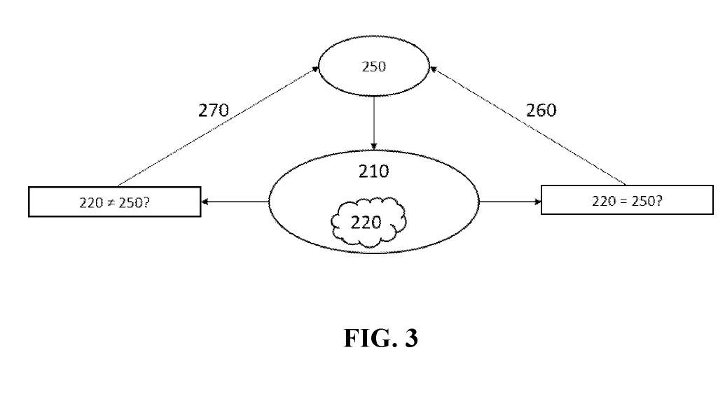

In another embodiment of the contemplated subject matter, and as depicted in FIGS. 2 and 3, a system 200 for authenticating paper or electronic checks 205 may comprise a server 210 configured to store a set of information 220 in a database 230. The database 230 may contain information 220 about a plurality of approved transactions 240. The server 210 is also configured to receive information about a first transaction 250 and compare this information with the information 220 of approved transactions stored in the database 230.

The server 210 is preferably configured to determine whether the first transaction 250 matches one of the approved transactions by comparing information about the first transaction 250 with the information 220 of the approved transactions 240. If a match is found, the server 210 may automatically transmit an authorization code 260 to approve the first transaction 250.

The first transaction 250 may be associated with a paper check 50 or an electronic check or transaction. The paper check may, typically, comprise a printed code 300, which may be included in the information about the first transaction received by the server. As discussed throughout, the printed code can be a serial number or a QR code, an indicia, pertinent check information, or other information. In some embodiments, the plurality of approved transactions 240 comprises a set of approved codes 290. These codes may be associated with each approved transaction and may serve as unique identifiers for the transactions.

In one embodiment, the server 210 is further configured to compare the printed code 300 to the set of approved codes 290 to determine whether the printed code 300 matches one of the approved codes 290. If the printed code 300 matches one of the approved codes 290, the server automatically transmits an authorization code 260 to approve the first transaction.

In other embodiments, the server 210 is configured to compare information about the first transaction with information about the approved transactions to determine if the first transaction matches a pre-approved transaction stored in the database. The information received about the first transaction could include one or more of a check number, a payee, an amount, a date of the transaction or printed date on the check, a signature, an image of the check, a printed code, image or other indicia printed on the check, and so forth.

Each of the approved transactions stored in the database may comprise additional information such as the identity of a payee, an amount of the transaction, a date, a check number, and so forth. This information may be used in the comparison process to further verify the authenticity of the transaction.

Of course, the comparison could involve additional or different information of the first transaction including, for example, comparing an indicia on the check with indicia in the database, comparing a payee on the check with payees in the database, and so forth. Preferably, two or more pieces of information are compared in the database to ensure only preauthorized transactions are approved.

In certain embodiments, if the first transaction 250 does not match one of the plurality of approved transactions 240, the server 210 may automatically transmit a decline code 280 to decline or flag the first transaction 250. If a decline code is transmitted, an account holder is typically notified that suspicious or fraudulent behavior has been detected. This can help prevent fraudulent or unauthorized transactions from being processed.

Rather than outright declining the first transaction 250, it is contemplated that the server 210 could automatically request authentication of a transaction where a match is not found to a pre-approved transaction in the database. It is contemplated in such circumstances that the server 210 could send a request to the account holder via text message, push notification, or other communication protocol for approval of the transaction, such as by the account holder providing a unique code which may be automatically generated such as by using two-factor authentication or a software app that generated one-time passcodes, for example

The server 210 may be part of a bank system. The bank system is typically integrated with a mobile application and/or a website that can be accessed by an account holder, typically by entering a username/email and password. If the account holder chooses to submit information about the first transaction 250 to the bank system, such as by typing, scanning, uploading, or otherwise submitting information associated with the transaction to the bank system, the bank system may communicate such information to the server, which then determines whether the transaction 250 matches one of the plurality of approved transactions 240. For example, a printed code 300 associated with the first transaction 250 may be identical to a corresponding approved transaction 240, or the printed code 300 may be different from the approved transaction 240, but the printed code 300 exclusively matches or associates with its specific corresponding approved transaction 240. If the server 210 determines that the information about the first transaction 250 indeed matches one of the approved transactions 240, the bank system may send an authentication code 260 to the account holder. The authentication code 260 is contemplated as a potential second factor of authentication for an additional layer of security, the first factor potentially being the username and password used to access the bank system. The inventors contemplate that the authentication code 260 may immediately approve the first transaction 250 upon being transmitted, but in other embodiments, the authentication code 260 may be a request sent to an account holder, wherein the account holder has the option to approve or not approve the transaction. If the account holder approves or confirms the authentication code 260, the check 50 is activated. It is contemplated that the system may determine if the first transaction 250 is associated with an approved transaction 240 before, after, or at the same time as the system sends the authentication code 260 or receives confirmation.

It is further contemplated that the system 200 can validate checks 50 at the point of use by a recipient. For example, the recipient deposits a check 50 through a bank branch, ATM, or mobile deposit system. The bank system verifies the check’s serial number, amount, payee details, and any other specifications made by the account holder, against the activation record. If the check is active and matches the recorded parameters, the transaction proceeds. Otherwise, the transaction is flagged and/or declined. A request to approve the transaction could also be sent to the account holder contemporaneously to approve the transaction.

In a different embodiment, the inventors contemplate a system that includes a database record comprising a plurality of database record codes, a check comprising a printed code, wherein the printed code is associated with one of the database record codes, wherein an account holder logs into a bank system, wherein the account holder provides information associated with the printed code to the bank system, wherein the bank system determines if the printed code matches one of the database record codes, wherein the bank system sends to the account holder an authentication request, wherein the bank system, upon successful authentication, activates the check.

In addition to the individualization of check validation and simplified process of verification enabled by this invention, further significant advantages are provided. For example, the inventors contemplate that such system may be especially advantageous when integrated in payroll processing, personal transactions, and corporate disbursements. Regarding payroll processing, employers may activate payroll checks for specific employees and amounts, ensuring no unauthorized changes are made on the checks before they are deposited. Regarding personal transactions, individuals can activate checks for large payments, such as rent or purchases, with confidence in their security. Regarding corporate disbursements, companies can manage multiple checks efficiently, reducing fraud risks in high-volume transactions.

In further embodiments of the contemplated subject matter, the system disclosed may be integrated with existing systems for easy implementation. For example, the system leverages existing banking infrastructure, requiring minimal changes to current workflows. From the backend, the system integrates with a database record which stores database record codes, and may further store user settings, activation records of individual checks, audit trails of individual checks, and other data relevant to security of checks. From the frontend, the system is typically integrated with a mobile application and/or website interface for user interaction. It is contemplated that all information transmitted by or within the system is encrypted, minimizing any risks associated with bad actors intercepting unencrypted information. In some embodiments, the numbers expressing quantities of ingredients, properties such as concentration, reaction conditions, and so forth, used to describe and claim certain embodiments of the invention are to be understood as being modified in some instances by the term “about.” As used herein, the terms "about" and "approximately", when referring to a specified, measurable value (such as a parameter, an amount, a temporal duration, and the like), is meant to encompass the specified value and variations of and from the specified value, such as variations of +/-10% or less, alternatively +/-5% or less, alternatively +/-1% or less, alternatively +/-0.1% or less of and from the specified value, insofar as such variations are appropriate to perform in the disclosed embodiments. Thus, the value to which the modifier "about" or "approximately" refers is itself also specifically disclosed. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term "coupled to" is intended to include both direct coupling (in which two elements that are coupled to each other contact each other) and indirect coupling (in which at least one additional element is located between the two elements). Therefore, the terms "coupled to" and "coupled with" are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C …. and N, the text should be interpreted as requiring only one element from the group, not A plus N, or B plus N, etc.

What is claimed is:

1. A system for authenticating paper or electronic checks, comprising:
a server configured to store a set of information in a database, wherein the information comprises a plurality of approved transactions;
the server configured to receive a first transaction;
the server configured to compare information about the first transaction with the information to determine whether the first transaction matches one of the plurality of approved transactions;
if the first transaction matches one of the plurality of approved transactions, the server automatically transmits an authorization code to approve the first transaction.

2. The system of claim 1, wherein the information comprises a plurality of database record codes.

3. The system of claim 1, wherein the first transaction is associated with a paper check.

4. The system of claim 3, wherein the paper check comprises a printed code, and wherein the information about the first transaction comprises the printed code.

5. The system of claim 4, wherein the plurality of approved transactions comprises a set of approved codes, and wherein the server is further configured to compare the printed code to the set of approved codes to determine whether the printed code matches one of the approved codes, and if the printed code matches one of the approved codes, the server automatically transmits an authorization code to approve the first transaction.

6. The system of claim 4, wherein the printed code is a serial number or a QR code.

7. The system of claim 1, wherein each of the approved transactions comprises an identity of a payee and/or an amount.

8. The system of claim 1, wherein if the first transaction does not match one of the plurality of approved transactions, the server automatically transmits a decline code to decline or flag the first transaction.

9. The system of claim 1, wherein the first transaction is received from a retailer.

10. The system of claim 1, wherein the server is further configured to store information about each transaction received including the first transaction and the determination whether the transaction was approved.

11. The system of claim 1, wherein the plurality of approved transactions changes over time.

12. The system of claim 1, wherein at least one of the plurality of approved transactions comprises a date range or time range associated with the approved transaction, and wherein the server is configured to automatically transmits the authorization code to approve the first transaction only if the date or time when the request to approve is received matches the date range or time range associated with the matching approved transaction.

13. The system of claim 1, wherein the plurality of approved transactions stored in the database are received from one or more account holders associated with accounts at a bank.

14. A method of authenticating paper or electronic checks, comprising:
receiving information at a server about a plurality of approved transactions and storing the information in a database, wherein the server comprises a processor and a memory;
receiving information about a first transaction at the server;
the processor comparing the information about the first transaction with the information of the plurality of approved transactions to determine whether the first transaction matches one of the plurality of approved transactions;
if the first transaction matches one of the plurality of approved transactions, the processor automatically transmitting an authorization code to approve the first transaction.

15. The method of claim 14, wherein the first transaction is associated with a paper check, and wherein the paper check comprises a printed code, wherein the information about the first transaction comprises the printed code, wherein the plurality of approved transactions comprises a set of approved codes, and wherein the processor is further configured to compare the printed code to the set of approved codes to determine whether the printed code matches one of the approved codes, and if the printed code matches one of the approved codes, the processor automatically transmits an authorization code to approve the first transaction.

16. The method of claim 14, wherein the printed code is a serial number or a QR code.

17. The method of claim 14, wherein each of the approved transactions comprises an identity of a payee and/or an amount.

18. The method of claim 14, wherein if the first transaction does not match one of the plurality of approved transactions, the processor automatically transmits a decline code to decline or flag the first transaction.

19. The method of claim 14, wherein the server is further configured to store information about each transaction received including the first transaction and the determination whether the transaction was approved.

20. The method of claim 14, wherein at least one of the plurality of approved transactions comprises a date range or time range associated with the approved transaction, and wherein the server is configured to automatically transmits the authorization code to approve the first transaction only if the date or time when the request to approve is received matches the date range or time range associated with the matching approved transaction.
